(19) United States
(12) Patent Application Publication
(10) Pub. No.: US 2017/0343842 A1
(43) Pub. Date: Nov. 30, 2017

(54) LIQUID CRYSTAL DISPLAY PANEL

(71) Applicants: Xiamen Tianma Micro-Electronics Co., Ltd, Xiamen (CN); Tianma Micro-Electronics Co., Ltd., Shenzhen (CN)

(72) Inventors: Jiayou Yan, Xiamen (CN); Xiufeng Zhou, Xiamen (CN); Junyi Li, Xiamen (CN); Bingping Liu, Xiamen (CN); Lihua Zheng, Xiamen (CN); Liang Wen, Xiamen (CN); Guozhao Chen, Xiamen (CN); Poping Shen, Xiamen (CN)

(21) Appl. No.: 15/331,916

(22) Filed: Oct. 24, 2016

(30) Foreign Application Priority Data
May 27, 2016 (CN) 201610368170.4

(51) Int. Cl. G02F 1/1339; G02F 1/1333; G02F 1/1368; G02F 1/1362; G02F 1/1335

(52) U.S. Cl. CPC G02F 1/1339; G02F 1/136286; G02F 1/133514; G02F 1/1368; G02F 1/133345; G02F 1/13394; G02F 2001/136295; G02F 2202/28

(57) ABSTRACT

A liquid crystal display panel is disclosed. The liquid crystal display includes an array substrate comprising a thin film transistor device layer and a first film layer formed on the thin film transistor device layer; a color film substrate arranged corresponding to the array substrate; a liquid crystal layer formed between the array and color film substrates; a frame glue for binding the array and color film substrates; and a support structure formed between the array and color film substrate. The support structure comprises a support pillar formed on the color film substrate and a pad formed on the first film layer. The liquid crystal display panel comprises a display region and a non-display region surrounding the display region; and the support pillar and the pad are located within the non-display region of the liquid crystal display panel, and the support pillar is in contact with the pad.

### CROSS-REFERENCE TO RELATED APPLICATION

This application is related to and claims priority from Chinese Application No. 201610368170.4, filed on May 27, 2016, entitled “LIQUID CRYSTAL DISPLAY PANEL,” the entire disclosure of which is hereby incorporated by reference.

### TECHNICAL FIELD

The present disclosure generally relates to the field of displaying technology, and in particular, to a liquid crystal display panel.

### BACKGROUND

In the existing method of manufacturing a liquid crystal display panel, a plurality of array substrates are generally manufactured on a glass substrate, and a plurality of color film substrates are manufactured on another glass substrate.

Thereafter, a liquid crystal is dripped onto a display region of the array substrate, a frame glue is applied in a non-display region of the color film substrate, and the frame glue is in a closed shape surrounding the display region. Thereafter, the array substrate is aligned with the color film substrate, such that the frame glue and a planarization layer of the array substrate are extruded to form a display panel. In the display panel, a closed liquid crystal cell is formed between the array substrate and the color film substrate, and is vacuumized. The display panel is placed afterwards in the atmosphere such that liquid crystal molecules in the liquid crystal cell diffuse, and the frame glue is cured. Finally, the glass substrates having a plurality of array substrates and a plurality of color film substrates is cut, thereby obtaining a plurality of independent liquid crystal display panels.

In the liquid crystal display panel manufactured through the above manufacturing method, when the array substrate and the color film substrate are glued together, the frame glue coated on the color film substrate is not cured, such that the frame glue is in the form of a sticky liquid at this time, and the liquid crystal is also in the liquid form at the same time. Therefore, when the array substrate and the color film substrate are glued together, the liquid crystal molecules and the frame glue may squeeze each other. At this time, a mix and penetration may easily take place between the liquid crystal molecules and the frame glue that has not been cured. In other words, the frame glue that has not been cured may spread to the display region and enter the liquid crystal layer under the extrusion effect, resulting in inferior displaying.

### SUMMARY

In view of the above-mentioned defects or deficiencies in the prior art, it is expected to provide a liquid crystal display panel to solve the technical problem in the prior art.

In the first aspect, an embodiment provides a liquid crystal display panel, comprising: an array substrate, a color film substrate, a liquid crystal layer, a frame glue and a support structure. The array substrate comprises a thin film transistor device layer and a first film layer formed on the thin film transistor device layer. The color film substrate is arranged corresponding to the array substrate. The liquid crystal layer is formed between the array substrate and the color film substrate. The frame glue is used for binding the array substrate and the color film substrate. The support structure is formed between the array substrate and the color film substrate. The support structure comprises a support pillar formed on the color film substrate and a pad formed on the first film layer. The liquid crystal display panel comprises a display region and a non-display region surrounding the display region. The support pillar and the pad are located within the non-display region of the liquid crystal display panel, and the support pillar is in contact with the pad.

In accordance with one or more solutions provided by various embodiments in accordance with the present disclosure, a support structure is disposed between the frame glue and the liquid crystal layer of the liquid crystal display panel, to avoid the frame glue from being extruded into the liquid crystal layer in the process of aligning and fitting the array substrate and the color film substrate, which may generate the mixture and penetration phenomenon between the frame glue and the liquid crystal and impact the displaying effect of the liquid crystal display panel.

### BRIEF DESCRIPTION OF THE DRAWINGS

After reading detailed descriptions of non-limiting embodiments with reference to the following accompanying drawings, other features, objectives and advantages of the present application will be more apparent:

FIG. 1 shows a schematic structural view of a liquid crystal display panel according to one embodiment;

FIG. 2 is a cross-sectional view along A-A in FIG. 1;

FIG. 3 shows a schematic structural view of the liquid crystal display panel according to another embodiment;

FIG. 4 is a cross-sectional view along B-B in FIG. 3;

FIG. 5 is a schematic structural view in which the first metal line includes a plurality of first metal line segments according to the embodiment shown in FIG. 3;

FIG. 6 shows a schematic structural view of the liquid crystal display panel according to still another embodiment;

FIG. 7 is a cross-sectional view along C-C in FIG. 6 in which the first metal line and the second metal line are disposed on the same layer;

FIG. 8 is a cross-sectional view along C-C in FIG. 6 in which the first metal line and the second metal line are not disposed on the same layer;

FIG. 9 is a schematic cross-sectional structural view of the liquid crystal display panel according to still another embodiment;

FIG. 10 is a schematic cross-sectional structural view of the liquid crystal display panel according to still another embodiment;

FIG. 11 is a schematic cross-sectional view of the liquid crystal display panel according to one alternative implementation of the embodiment shown in FIG. 10; and

FIG. 12A to FIG. 12D is a schematic view showing respective structures and position relationship between the support pillar and the pad in the support structure of the liquid crystal display panel according to the present application.

### DETAILED DESCRIPTION OF EMBODIMENTS

The present application will be further described below in detail in combination with the accompanying drawings and the embodiments. It should be appreciated that the specific embodiments described herein are merely used as illustration, rather than being intended to be limiting. In addition, it should be noted that, for the ease of description, only relevant parts are shown in the accompanying drawings.

It should also be noted that the embodiments and the features in the embodiments may be combined with each other on a non-conflict basis. The present application will be described below in detail with reference to the accompanying drawings and in combination with the embodiments.

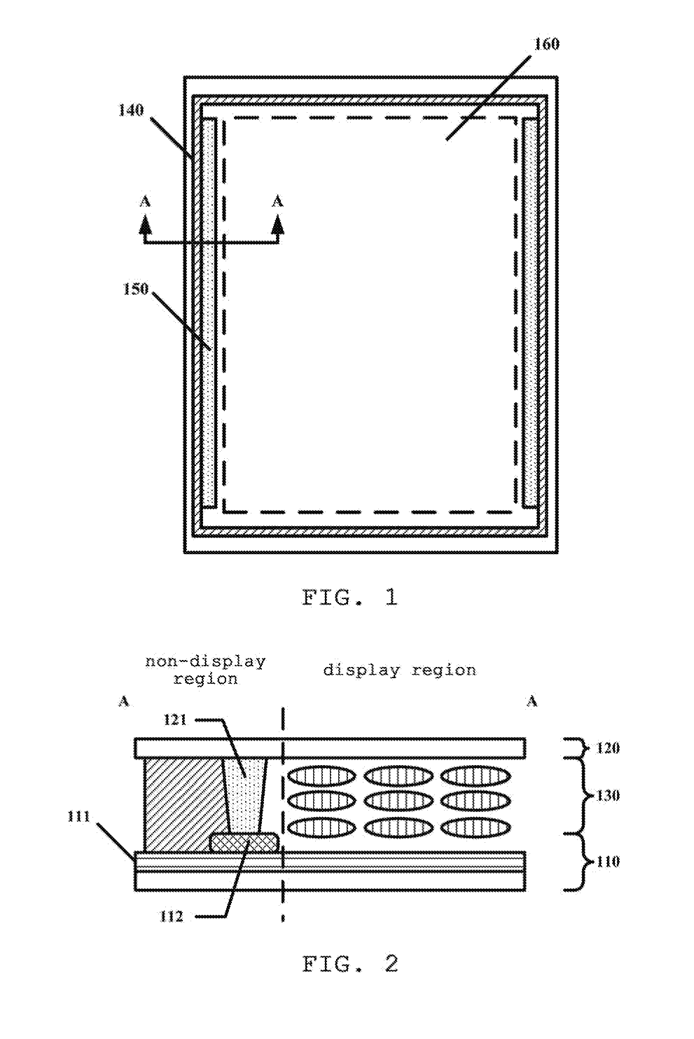

FIG. 1 is a schematic structural view of a liquid crystal display panel according to one embodiment; and FIG. 2 is a cross-sectional view along A-A in FIG. 1.

Herein, the liquid crystal display panel in the embodiment will be described with reference to FIGS. 1 and 2.

The liquid crystal display panel in this embodiment includes an array substrate 110, a color film substrate 120 disposed corresponding to the array substrate 110, a liquid crystal layer 130 formed between the array substrate 110 and the color film substrate 120, and a frame glue 140 for binding the array substrate 110 and the color film substrate 120.

The array substrate 110 includes a thin film transistor device layer 111 and a first film layer formed above the thin film transistor device layer 111.

The liquid crystal display panel further includes a support structure 150 formed between the array substrate 110 and the color film substrate 120. Herein, the support structure 150 includes a support pillar 121 formed on the color film substrate 120 and a pad 112 formed on the first film layer.

The liquid crystal display panel includes a display region 160 and a non-display region surrounding the display region. The support pillar 121 and the pad 112 are located within the non-display region of the liquid crystal display panel, and the support pillar 121 is in contact with the pad 112.

According to the liquid crystal display panel in this embodiment, a support structure 150 is disposed in the non-display region, so as to avoid 1) the frame glue 140 and the liquid crystal layer 130 from contacting with each other, 2) the mixture and penetration phenomenon generated between the frame glue and the liquid crystal layer caused by the contact between the frame glue that has not been cured and the liquid crystal layer, and 3) the frame glue, under the effect of extrusion, from diffusing into the display region of the liquid crystal display panel and entering the liquid crystal layer to result in inferior displaying, in the process of aligning and fitting the array substrate and the color film substrate.

In some implementations, as shown in FIG. 1 and FIG. 2, a minimum distance from the support structure 150 to the display region 160 of the liquid crystal display panel is less than a minimum distance from the frame glue 140 to the display region 160 of the liquid crystal display panel. That is, in the alternative implementations, the support structure 150 is disposed between the frame glue 140 and the display region 160, which can better prevent the frame glue, under the effect of extrusion, from diffusing into the display region 160 of the liquid crystal display panel and entering the liquid crystal layer 130.

In some implementations, the support structure 150 is formed in the non-display region proximate to at least one side of the display region 160. That is, in the alternative implementations, the support structure may be formed on any side of the non-display region in the liquid crystal display panel, for example, formed on one or more sides of the left side, the right side, the upper side, and the lower side of the liquid crystal display panel. For example, as shown in FIG. 1, the support structure 150 may be formed on the left and right sides of the liquid crystal display panel. In some applications, the left and right sides of the liquid crystal display panel are provided with no electrical components for forming a circuit, and thus the frame glue 140, under the effect of extrusion, will directly contact with the liquid crystal layer, in the process of aligning and fitting the array substrate 110 and the color film substrate 120. However, as shown in FIG. 1, the support structure 150 formed on the left and right sides of the liquid crystal display panel can avoid the frame glue 140, under the effect of extrusion, from diffusing into the display region and entering the liquid crystal layer 130 in the process of aligning and fitting the array substrate 110 and the color film substrate 120. In another aspect, each of the upper and lower sides of the liquid crystal display panel is generally provided with some electrical components for forming a circuit, and thus the position of coating the frame glue 140 on the upper and lower sides of the liquid crystal display panel is relatively far away from the display region. In the process of aligning and fitting the array substrate 110 and the color film substrate 120, the probability for the frame glue 140 formed on the upper and lower sides of the color film substrate 110, under the effect of extrusion, to be in contact with the liquid crystal layer is low. Therefore, the support structure 150 is not provided on the upper and lower sides of the liquid crystal display panel, which may on one hand avoid the frame border on the upper and lower sides of the liquid crystal display panel from being further increased, and on the other hand avoid the cost of manufacturing the liquid crystal display panel from being increased.

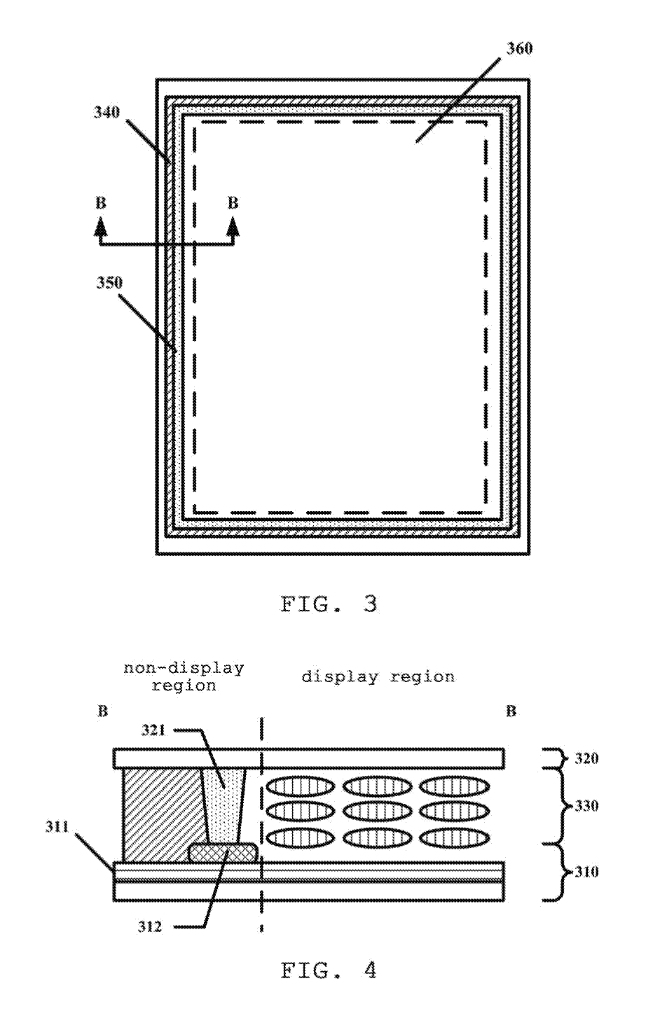

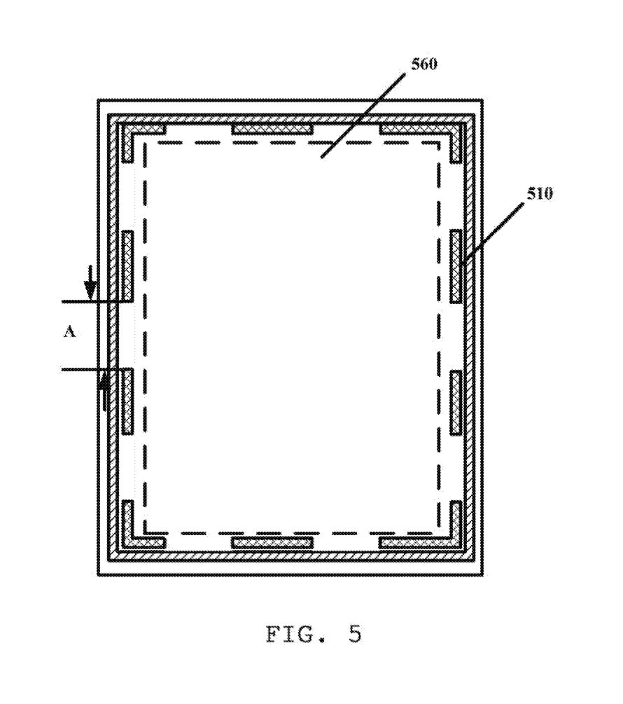

FIG. 3 shows a schematic structural view of the liquid crystal display panel according to another embodiment; and FIG. 4 is a cross-sectional view along B-B in FIG. 3.

As shown in FIG. 3 and FIG. 4, similar to the embodiment shown in FIG. 1 and FIG. 2, the liquid crystal display panel in this embodiment also includes an array substrate 310, a color film substrate 320 disposed corresponding to the array substrate 310, a liquid crystal layer 330 formed between the array substrate 310 and the color film substrate 320, and a frame glue 340 for binding the array substrate 310 and the color film substrate 320.

The array substrate 310 includes a thin film transistor device layer 311 and a first film layer formed above the thin film transistor device layer 311.

The liquid crystal display panel further includes a support structure 350 formed between the array substrate 310 and the color film substrate 320. Herein, the support structure 350 includes a support pillar 321 formed on the color film substrate 320 and a pad 312 formed on the first film layer.

The liquid crystal display panel includes a display region 360 and a non-display region surrounding the display region. The support pillar 321 and the pad 312 are located within the non-display region of the liquid crystal display panel, and the support pillar 321 is in contact with the pad 312.

Different from the embodiment shown in FIG. 1 and FIG. 2, the pad 312 in this embodiment may include a first metal line that is in contact with the support pillar 321.

In some applications, a certain metal line, which is formed on a part of the first film layer located in the non-display region for providing electrical signals to the liquid crystal display panel, is further used as the first metal line in the support structure 350. This will simplify the process of manufacturing the support structure 350 and reduce the space occupied by the support structure 350 in the non-display region, thereby facilitating a narrow frame border of the display panel.

In some implementations, an orthographic projection of the first metal line to the array substrate 310 can form a closed first outline surrounding the display region 360. In this way, the first metal line forming a closed outline can better isolate the liquid crystal layer 330 from the frame glue 340, and can better prevent the frame glue 340, under the effect of extrusion, from diffusing into the display region 360 of the liquid crystal display panel and entering the liquid crystal layer 330. Herein, the first outline may be, but is not limited to, a rectangle or a rectangle with rounded corners.

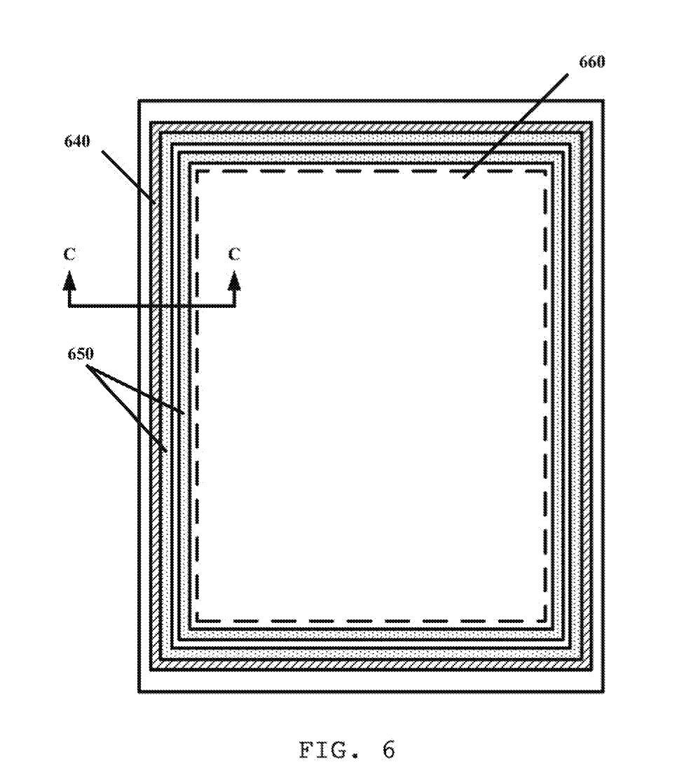

In some implementations, as shown in FIG. 5, the first metal line may include a plurality of first metal line segments 510 insulated from each other. Each of the first metal line segments is located on a closed second outline surrounding the display region 560.

As shown in FIG. 5, the first metal line segments 510 can be deemed as “segments of a dotted line” on a continuous and closed second outline. Moreover, the spacing A between adjacent first metal line segments 510 may meet the following criteria: 1 μm≦A≦1 cm.

In this way, since the first metal line segments are insulated from each other and a plurality of signal lines of the liquid crystal display panel can be further used as the first metal line segments 510 in the first metal line, signal lines on the liquid crystal display panel may be multi-used, and the space occupied by the support structure in the non-display region may be reduced, thereby facilitating a narrow frame border of the display panel.

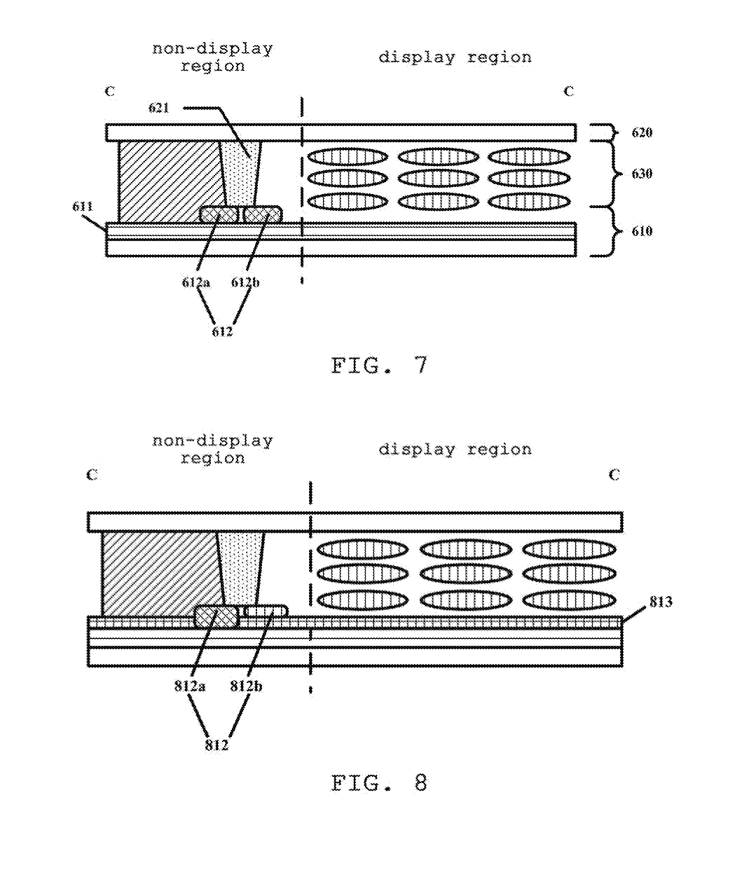

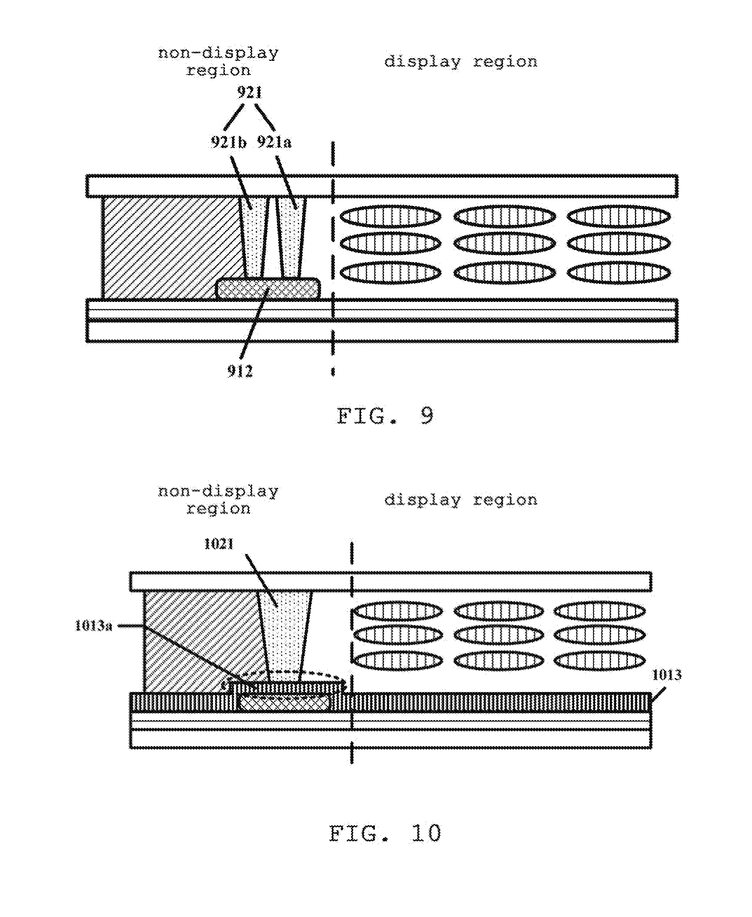

FIG. 6 is a schematic structural view of the liquid crystal display panel according to another embodiment; and FIG. 7 is a cross-sectional view along C-C in FIG. 6 when the first metal line and the second metal line are disposed on the same layer.

Similar to the embodiment shown in FIG. 3, the liquid crystal display panel in this embodiment also includes an array substrate 610, a color film substrate 620 disposed corresponding to the array substrate 610, a liquid crystal layer 630 formed between the array substrate 610 and the color film substrate 620, and a frame glue 640 for binding the array substrate 610 and the color film substrate 620.

The array substrate 610 includes a thin film transistor device layer 611 and a first film layer formed above the thin film transistor device layer 611.

The liquid crystal display panel further includes a support structure 650 formed between the array substrate 610 and the color film substrate 620. Herein, the support structure 650 includes a support pillar 621 formed on the color film substrate 620 and a pad 612 formed on the first film layer.

The liquid crystal display panel includes a display region 660 and a non-display region surrounding the display region 660. The support pillar 621 and the pad 612 are located within the non-display region of the liquid crystal display panel, and the support pillar 621 is in contact with the pad 612. The pad 612 in the embodiment may also include a first metal line 612a, and the first metal line 612a is in contact with the support pillar 621.

In addition, different from the embodiment shown in FIG. 3, in this embodiment, the pad further includes a second metal line 612b.

As shown in FIG. 7, the support pillar 621 may be in contact with the second metal line 612b.

In some implementations, the first film layer includes at least one metal layer. In some applications of the alternative implementations, as shown in FIG. 7, the first metal line 612a and the second metal line 612b may be located on the same metal layer in the first film layer.

Alternatively, in some implementations, as shown in FIG. 8, the first metal line 812a and the second metal line 812b may be located on different metal layers in the first film layer. In these applications, the first film layer may further include an insulation layer located between the metal layer on which the first metal line 812a is located and the metal layer on which the second metal line 812b is located.

In some implementations, in the liquid crystal display panel of the embodiment, an orthographic projection of the second metal line 612b, 812b to the array substrate may form a closed third outline surrounding the display region. Alternatively, the second metal line 612b, 812b may include a plurality of second metal line segments insulated from each other, and each of the second metal line segments is located on a closed fourth outline surrounding the display region. That is, the second metal line 612b, 812b in the embodiment may be either a continuous end-to-end metal line or metal line segments located on a certain continuous and closed outline.

In addition, it should be noted that, although FIG. 6 to FIG. 8 illustrate that the second metal line 612b, 812b is located between the first metal line 612a, 812a and the display region, the position relationship is merely illustrative. In practice, the first metal line and second metal line may exchange their positions. In addition, each of the first metal line and the second metal line may be a continuous and closed metal line, or may be metal line segments located on a certain continuous and closed outline.

In some embodiments, in the support structure of the liquid crystal display panel of the present application, the support pillar may include a plurality of supporters separated from each other. An orthographic projection of each of the supporters to the array substrate at least partially overlaps with a closed fifth outline, each of the supporters is in contact with the pad, and the fifth outline surrounds the display region. A spacing B between adjacent supporters may meet: 1 μm≦B≦1 cm. Herein, the fifth outline may be in the shape of a rectangle or a rectangle with rounded corners.

In some embodiments, in the support structure of the liquid crystal display panel of the present application, an orthographic projection of the support pillar to the array substrate may form a closed sixth outline surrounding the display region. Similarly, the sixth outline may also be in the shape of a rectangle or a rectangle with rounded corners.

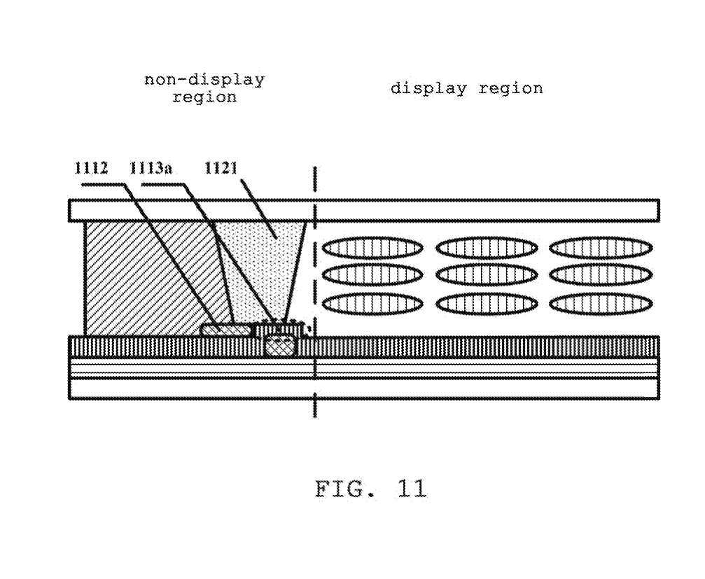

FIG. 9 is a schematic cross-sectional structural view of the liquid crystal display panel according to another embodiment.

In the embodiment, the support pillar 921 may include first a support member 921a and at least one second support member 921b separated from each other.

The first support member 921a is located between the second support member 921b and the frame glue 940, and the first support member 921a and the second support member 921b are both in contact with the pad. In the embodiment, the pad may take the form of the pad described in the above embodiments, for example, FIG. 9 illustrates that the pad includes a first metal line 912.

Since the liquid crystal display panel in the embodiment includes the first support member 921a and the second support member 921b, the frame glue can be prevented from being extruded into the display region and the mixture and penetration phenomenon generated between the frame glue and the liquid crystal can be avoided, in the process of aligning and fitting the array substrate and the color film substrate.

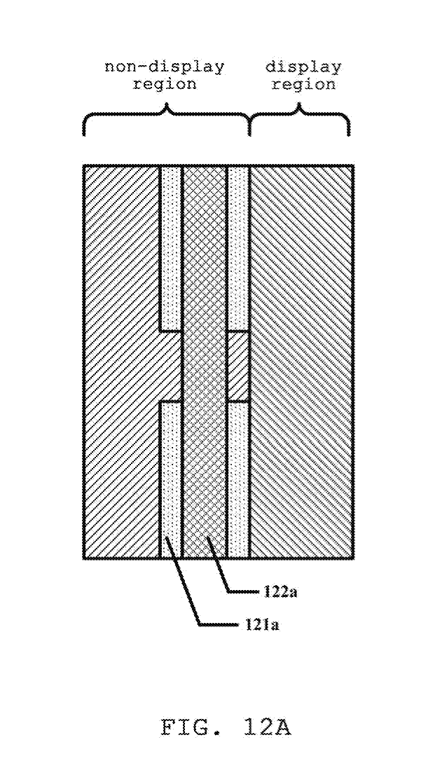

FIG. 10 is a schematic cross-sectional view of the liquid crystal display panel according to another embodiment.

In this embodiment, the first film layer may include an insulation layer 1013, and the pad may further include an insulation pad 1013a formed in the insulation layer 1013. The support pillar 1021 may be in contact with at least a part of the insulation pad 1013a.

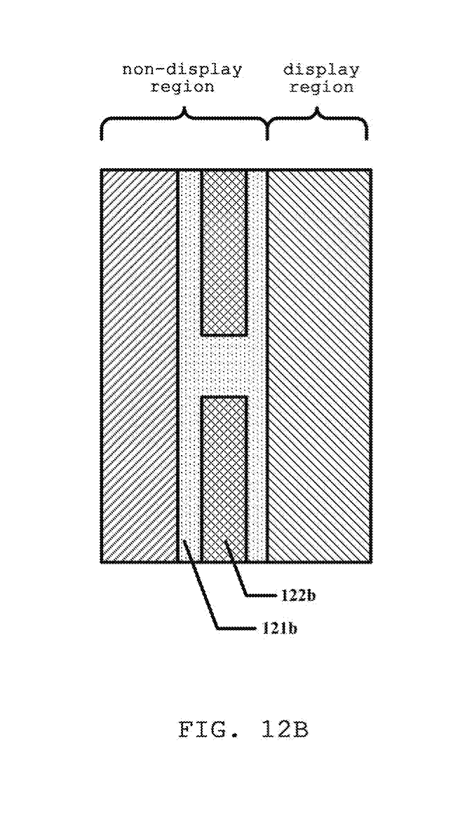

For example, in some alternative implementations, as shown in FIG. 10, the lower surface of the support pillar 1021 is completely in contact with the insulation pad 1013a. Alternatively, in some other alternative implementations, as shown in FIG. 11, apart of the lower surface of the support pillar 1121 may be in contact with the insulation pad 1113a, and another part of the lower surface of the support pillar 1121 is in contact with the metal pad 1112.

In addition, in the liquid crystal display panel according to various embodiments, the support pillar and the first film layer may form an interference fit. That is, during the contact between the support pillar and the first film layer, an action force and a reaction force generated therebetween are larger than the gravity of the support pillar, such that the contacting surfaces of the support pillar and the first film layer tightly fit with each other, thereby further preventing the frame glue, under the effect of extrusion, from entering the display region of the liquid crystal display panel through the contact surfaces of the support pillar and the first film layer in the process of aligning and fitting the array substrate and the color film substrate of the liquid crystal display panel.

In addition, in the liquid crystal display panel according to various embodiments, the support pillar may be formed in the same manufacturing process as a spacer formed on the array substrate to keep the cell thickness of the crystal display panel. Alternatively, the support pillar may also be formed by stacking film layers (including but not limited to a plurality of color filter layers, a light shielding layer, and on the like) of the color film substrate.

In addition, in the support structure of the liquid crystal display panel according to embodiments of the present application, the structures of the support pillar and the pad may have various combinations.

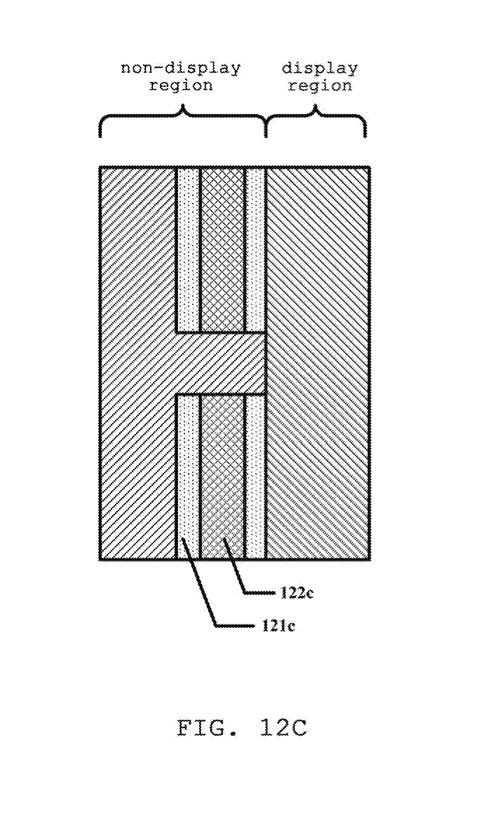

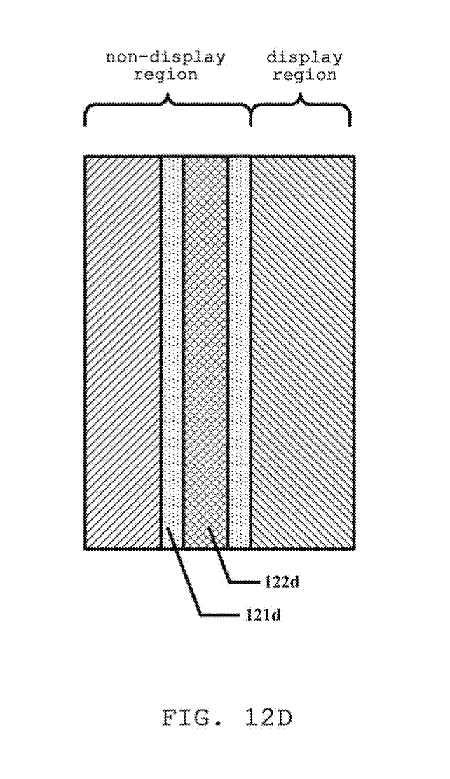

For example, the support structure may be as shown in FIG. 12A, that is, an orthographic projection of the pad 121a onto the array substrate may be non-continuous, and an orthographic projection of the support pillar 122a onto the array substrate may be continuous.

Alternatively, as shown in FIG. 12B, an orthographic projection of the support pillar 122b onto the array substrate may be non-continuous (that is, the support pillar 122b includes a plurality of supporters separated from each other), and an orthographic projection of the pad 121b onto the array substrate may be continuous.

Alternatively, as shown in FIG. 12C, orthographic projections of the pad 121c and the support pillar 122c onto the array substrate are both non-continuous.

Alternatively, as shown in FIG. 12D, orthographic projections of the pad 121d and the support pillar 122d onto the array substrate are both continuous.

Alternatively, when the pad in the support structure includes a plurality of metal lines and/or insulation pads, the projection of a certain or several metal lines and/or insulation pads onto the array substrate may be continuous, and the projection of one or more other metal lines and/or insulation pads onto the array substrate may be non-continuous.

Similarly, when more than one support pillar in the support structure is provided, the projection of one or more of the support pillars onto the array substrate may be continuous (that is, the projection of the one or more of the support pillars onto the array substrate is a continuous and closed outline), and the projection of one or more other support pillars onto the array substrate is non-continuous (that is, the one or more other support pillars include a plurality of supporters separated from each other).

It should be appreciated by those skilled in the art that the inventive scope of the present application is not limited to the technical solutions formed by the particular combinations of the above technical features. The inventive scope should also cover other technical solutions formed by any combinations of the above technical features or equivalent features thereof without departing from the concept of the invention, such as, technical solutions formed by replacing the features as disclosed in the present application with (but not limited to), technical features with similar functions.

What is claimed is:

1. A liquid crystal display panel, comprising:
an array substrate comprising a thin film transistor device layer and a first film layer formed on the thin film transistor device layer;
a color film substrate arranged corresponding to the array substrate;
a liquid crystal layer formed between the array substrate and the color film substrate;
a frame glue for binding the array substrate and the color film substrate; and
a support structure formed between the array substrate and the color film substrate; and, wherein
the support structure comprises a support pillar formed on the color film substrate and a pad formed on the first film layer;
the liquid crystal display panel comprises a display region and a non-display region surrounding the display region; and
the support pillar and the pad are located within the non-display region of the liquid crystal display panel, and the support pillar is in contact with the pad.

2. The liquid crystal display panel according to claim 1, wherein
a minimum distance from the support structure to the display region of the liquid crystal display panel is less than a minimum distance from the frame glue to the display region of the liquid crystal display panel.

3. The liquid crystal display panel according to claim 2, wherein
the support structure is formed in the non-display region proximate to at least one side of the display region.

4. The liquid crystal display panel according to claim 1, wherein
the pad comprises a first metal line.

5. The liquid crystal display panel according to claim 4, wherein
the first metal line is in contact with the support pillar.

6. The liquid crystal display panel according to claim 5, wherein
an orthographic projection of the first metal line to the array substrate forms a closed first outline surrounding the display region.

7. The liquid crystal display panel according to claim 6, wherein
the first outline is in a shape of a rectangle or a rectangle with rounded corners.

8. The liquid crystal display panel according to claim 5, wherein
the first metal line comprises a plurality of independently insulated first metal line segments, each of the first metal line segments is located on a closed second outline surrounding the display region; and
a spacing A between adjacent first metal line segments meets the following criteria:
1 μm≦A≦1 cm.

9. The liquid crystal display panel according to claim 4, wherein the pad further comprises a second metal line.

10. The liquid crystal display panel according to claim 9, wherein the support pillar is in contact with the second metal line.

11. The liquid crystal display panel according to claim 9, wherein
the first film layer comprises at least one metal layer; and
the first metal line and the second metal line are located on a same metal layer in the first film layer, or the first metal line and the second metal line are located on different metal layers in the first film layer.

12. The liquid crystal display panel according to claim 9, wherein
an orthographic projection of the second metal line to the array substrate forms a closed third outline surrounding the display region; or
the second metal line comprises a plurality of independently insulated second metal line segments, each of the second metal line segments is located on a closed fourth outline surrounding the display region.

13. The liquid crystal display panel according to claim 1, wherein
the support pillar comprises a plurality of separate supporters, an orthographic projection of each of the supporters to the array substrate at least partially overlaps with a closed fifth outline, each of the supporters is in contact with the pad, the fifth outline surrounds the display region; and
a spacing B between adjacent supporters meets the following criteria:
1 μm≦B≦1 cm.

14. The liquid crystal display panel according to claim 13, wherein
the fifth outline is in a shape of a rectangle or a rectangle with rounded corners.

15. The liquid crystal display panel according to claim 1, wherein
an orthographic projection of the support pillar to the array substrate forms a closed sixth outline surrounding the display region.

16. The liquid crystal display panel according to claim 15, wherein
the sixth outline is in a shape of a rectangle or a rectangle with rounded corners.

17. The liquid crystal display panel according to claim 1, wherein
the support pillar comprises a first support member and at least one second support member separated from each other;
the first support member is located between the second support member and the frame glue; and
the first support member and the second support member are in contact with the pad.

18. The liquid crystal display panel according to claim 1, wherein
the first film layer comprises an insulation layer;
the pad comprises an insulation pad formed on the insulation layer; and
the support pillar is in contact with at least a part of the insulation pad.

19. The liquid crystal display panel according to claim 1, wherein
the support pillar and the first film layer form an interference fit.
